(19) United States
(12) Patent Application Publication
(10) Pub. No.: US 2025/0086620 A1
(43) Pub. Date: Mar. 13, 2025

(54) PRIVACY-PRESERVING PAYMENT EXCHANGE

(71) Applicant: Adeia Guides Inc., San Jose, CA (US)

(72) Inventors: Markku Kylänpää, Helsinki (FI); Ville Ollikainen, Vihti (FI); Dhananjay Lal, Englewood, CO (US); Tao Chen, Palo Alto, CA (US); Serhad Doken, Bryn Mawr, PA (US); Jean-Yves Couleaud, Mission Viejo, CA (US); Anni Karinsalo, Oulu (FI); Pekka Koskela, Oulu (FI)

(21) Appl. No.: 18/244,721

(22) Filed: Sep. 11, 2023

(51) Int. Cl. G06Q 20/38

(52) U.S. Cl. CPC G06Q 20/383; G06Q 20/3825; G06Q 20/3829

(57) ABSTRACT

A problem with online transactions is that a customer may unwillingly be profiled by a corporate entity. To hinder such profiling, a customer may occasionally generate a public/private key pair, and present the public key to a digital token service for use as a pseudonym included in tokens issued to the customer. A subsequent assignment of the digital token to a corporate entity can then be performed by adding the public key of the corporate entity to the token, and signing the combination with the private key which pairs with the pseudonymous public key in the token. A return transaction from the corporate entity to the customer can then add the pseudonymous public key to a return digital token and sign the combination with the corporate entity's private key. Routing the digital token to the customer may be achieved by replying directly to the anonymous inbound token.

### BACKGROUND

The present disclosure relates to methods enabling payments between two parties, in which at least one of the parties is able to keep their identity hidden from the other party despite payments being made in both directions between the parties. The disclosure has particular utility in relation to online betting systems, especially online micro-betting systems.

As in other fields, many companies involved in providing online betting services operate a business model which relies on gathering data on consumers' habits and either using that data to pitch relevant services to the consumer, or selling that data onto third parties. Digital interactions now present in online betting mean that collecting a large volume of data about a consumer's activities has become much easier.

Online betting providers and other counterparties can learn a consumer's identity in many ways, some of which are not known to the majority of consumers. For example, a counterparty can learn a user's network address and log content access requests arriving from that address in order to build a user profile. Sophisticated consumers may counter such identification techniques by accessing the counterparty's server through a Virtual Private Network (VPN), or by using the Tor browser-which orchestrates so-called onion routing in a network of peers between the consumer and the counterparty. However, despite such precautions, a consumer might nevertheless reveal their identity to a counterparty through payments made by them to the counterparty, or payments received by them from the counterparty.

The present disclosure helps to address these issues by providing techniques for making privacy-preserving payments to a counterparty, and receiving privacy-preserving payments from a counterparty.

### SUMMARY

The disclosure relates to systems and methods for supporting two-way digital transactions between parties. A problem with such transactions is that one or both of the parties may be profiled by the other. Often, one of the parties is a corporate entity which profiles a retail customer (the other party) based on information in the transactions which that retail customer makes with the corporate entity. In order to provide anonymity in two-way digital transactions, a retail customer may periodically or occasionally generate a public/private key pair, and present the public key to a digital token service for use as a pseudonym included in tokens issued to the retail customer. A subsequent assignment of the digital token to the corporate entity can then be performed by adding the public key of the corporate entity to the token, and signing the combination with the private key which pairs with the pseudonymous public key in the token. A return digital-token-based transaction from the corporate entity to the retail customer can then be made by adding the pseudonymous public key to the return digital token and signing the combination with the corporate entity's private key. Routing the digital token to the anonymous retail customer may be achieved by replying directly to an anonymous message including the retail customer's digital payment token.

In some scenarios-online betting is an example—conditional anonymity is desirable where the retail customer's identity is hidden unless and until the retail customer engages in an excessive volume of transactions with the corporate entity. To achieve such conditional anonymity, a public user identifier (e.g., the user's full name and address, or the user's email address) may be treated as a secret, and secret-sharing or secret splitting techniques may be used to divide the public user identifier into shares or hints, with each transaction revealing one or more shares of the public user identifier. The parameters of the secret-sharing technique can be chosen such that a volume of transactions which exceeds a threshold provides sufficient shares to reveal the public identity of the retail customer. The technique is of particular use in online anonymous gambling where it is desirable to identify retail gamblers who have a gambling addiction, and to take steps to prevent or lessen the impact of that addiction on the gambling addict.

A privacy-preserving payment exchange method which maintains consumer anonymity is provided by having a consumer first prepare to make a payment to a counterparty by generating an ephemeral consumer public-private key pair, and then, in some embodiments, purchasing one or more digital payment tokens by sending the ephemeral consumer public key (but keeping the ephemeral consumer private key secret) and monetary payment to a token service.

The digital payment tokens returned by the token service include the consumer public key but do not include an indication of the consumer's identity. The consumer then subsequently makes the payment to the counterparty by adding a first assignment layer to the digital payment token by combining the digital payment token with a public key of the counterparty and digitally signing the combination with the consumer ephemeral private key.

In other embodiments, the consumer may use a token received from another party instead of a token received from the token service.

The counterparty extracts the consumer ephemeral public key from the digital payment token received from the consumer, and calculates a return payment payable to the consumer. The counterparty then makes the return payment adding a return assignment layer to a return digital payment token by adding at least the consumer ephemeral public key to the return digital payment token and digitally signing the combination with a counterparty private key (which may or may not correspond to the counterparty public key found in the inbound digital payment token). In some embodiments, the return digital payment token comprises the inbound digital payment token, so that the outbound digital payment token comprises the inbound digital payment token and the return assignment layer.

An ephemeral public-private key pair is one which is used for a time-period which is sufficiently short to prevent or hinder attempts by others to tie together payments from a given consumer, and thereby build a profile of the consumer by linking online transactions involving the same consumer identification. A new consumer ephemeral public-private key pair may, for example, be generated for each digital payment token, for each purchase of a batch of digital payment tokens, for each online payment, or with a given frequency (e.g. hourly, more frequently than hourly, daily, more frequently than daily, weekly or more frequently than weekly), and/or each time a given amount of expenditure by the consumer on digital payment tokens is reached (e.g. $100, $500, $1,000 etc.).

In some embodiments, a plurality of inbound digital payment tokens are received from a consumer, and each of the plurality of inbound digital payment tokens further includes a tracking payload including a hint of a consumer identifier, and the method further comprises storing the received hints for each consumer, and reconstructing a consumer identity in response to receiving sufficient hints to reveal a consumer identity. In this way, the anonymity provided by the use of an ephemeral consumer public key is tempered by traceability of the true identity of the consumer in the event that the consumer exceeds a token spending threshold.

In some embodiments, the hints are processed by a control service separate from (e.g., administered by a different administrator, running in a different execution environment, or geographically remote from) the service which handles the digital payment exchange. In some variants of those embodiments, the tracking payload is encrypted, and a control service is arranged in operation to decrypt the tracking payload using a cryptographic key and perform the steps of storing the received hints for each consumer and reconstructing the consumer identity. The cryptographic key may be a symmetric cryptography key shared by the control service and the tracking service, or, when asymmetric cryptography is used to hide the tracking payload from entities other than the control service, it may be a private key corresponding to a public key used to encrypt the tracking payload.

In some embodiments, the method further comprises receiving from the consumer, a consumer ephemeral certificate in which data comprising the consumer public key is signed with a token service private key.

In some embodiments, the method further comprises, in response to reconstructing the consumer identity, sending a request to the token service to at least reduce the provision of digital payment tokens to the identified consumer.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an example user interface generated by an anonymous micro-betting website;

FIG. 2 illustrates an anonymous online micro-betting system;

FIG. 3 illustrates the hardware and software architecture of a user device;

FIG. 4 is a flowchart illustrating a process by which a user sets up an account with a digital payment token service;

FIG. 5A illustrates a user profile stored by a token service;

FIG. 5B illustrates an identity hint cache maintained by a betting control service;

FIG. 6 is a flowchart illustrating a process by which a user purchases anonymous digital payment tokens from a token service;

FIG. 7 is a flowchart illustrating the generation of each digital payment token in more detail;

FIG. 8 is a flowchart illustrating the generation of digital certificates by the token service;

FIG. 9 is a flowchart illustrating the submission of an anonymous bet by the user to the betting platform;

FIG. 10 is a flowchart illustrating the verification of digital payment tokens provided by the user device in more detail;

FIG. 11 is a flowchart illustrating the use of a control service to determine whether to handle an anonymous user bet;

FIG. 12 is a flowchart illustrating a cache clearing process performed by the control service;

FIG. 13 is a flowchart illustrating how the control service determines whether the anonymous user has breached a betting limit;

FIG. 14 is a flowchart showing the processes performed by the betting platform in response to receiving the determination from the control service.

### DETAILED DESCRIPTION

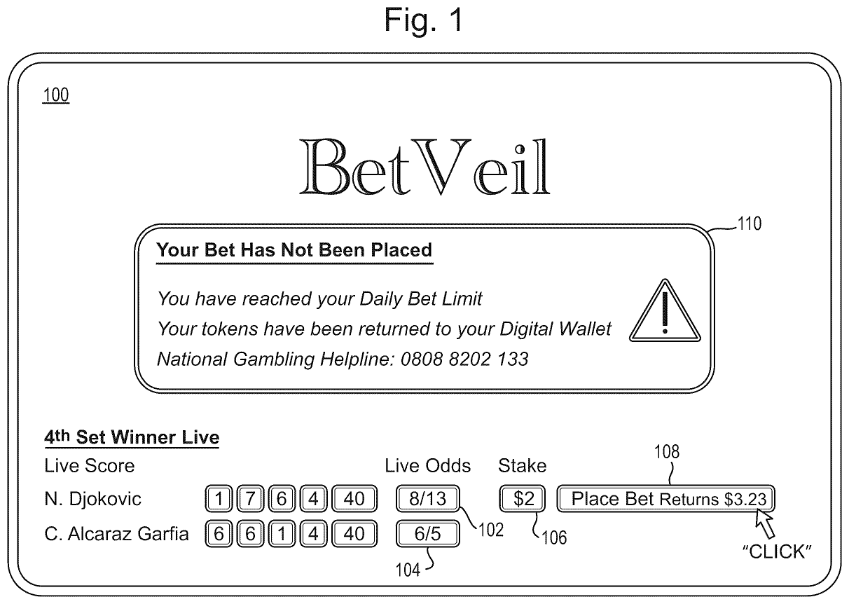

FIG. 1 shows an example graphical user interface 100 displayed by an anonymous micro-betting application on a user device. They user device may be a desktop computer, a laptop computer, a tablet computer or a smartphone for example. The user interface offers in-play betting on live events such as sporting events. The interface indicates the current state of the event and gives live odds in relation to situations that occur during the event. In the example illustrated here, the event is a tennis match and live odds 102, 104 are given on which of the two players in a tennis match will win the fourth set. The live score is displayed to the user, and shows which players are playing in the match, the number of games won in previous sets, and the current situation in the fourth set, both in terms of games won by each player in each set, the points score in the game currently underway, and an indication of which of the players is serving. The interface includes a field 106 in which a user can enter an amount to be staked on the bet. In response to the user entering an amount to be staked into the field 106, a ‘Place Bet’ button 108 is generated which the user can manually select (e.g., by clicking with a mouse in windowing interface, or by touching with their finger on a touchscreen interface). To assist the user in making a decision whether to place the bet, the returns offered to the user in the event that they win the bet are displayed on or alongside the ‘Place Bet’ button.

If the user activates the ‘Place Bet’ button, the technology set forth in the present disclosure is used to decide whether the user has reached a predetermined betting limit. This represents a technical challenge owing to the user not directly disclosing their identity to the anonymous betting platform, and hence there being no straightforward way of attributing bets to a given user. The user and/or the betting platform may set limits on the amount or value of bets that might be placed within a given timeframe. If the technology set forth in the present disclosure determines that the user betting limit would be reached or exceeded were the requested bet to be placed in response to the activation of the ‘Place Bet’ button, then the bet is rejected, and an alert explaining the rejection of the bet is displayed.

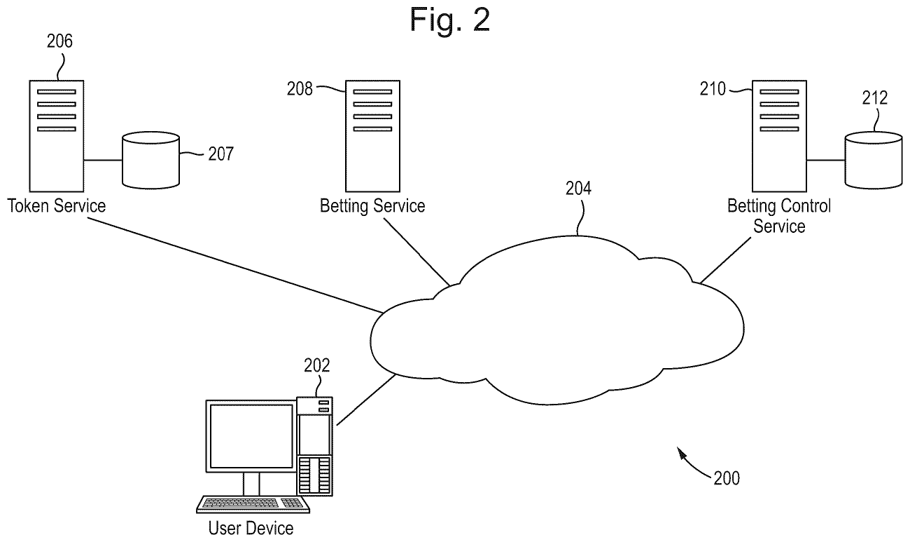

Aspects of an illustrative hardware and software architecture of the disclosure will now be described with reference to the example shown in FIG. 2.

A computer network 200 comprises a user device 202, interconnected via a communications network 204 (which may be provided by the Internet) to a token server 206 with associated persistent storage 207, a betting service 208, and a betting control service 210 with associated persistent storage 212. In some embodiments, two or more of these functions might be hosted on a single server or set of servers. In particular, a single server or set of servers under common control might offer a betting service and a betting control service. The persistent storage 212 associated with the betting control service caches user identity hints for each user as will be described below.

In some cases, in order to hide the network addresses of the User Device 202 from the computer network 200, a network address translation node or virtual private network might be interposed between the User Device 202 and the computer network 200.

Each of the token service 206, betting service 208 and betting control service 210 may be provided by a computer server running database server, application server and web server programs.

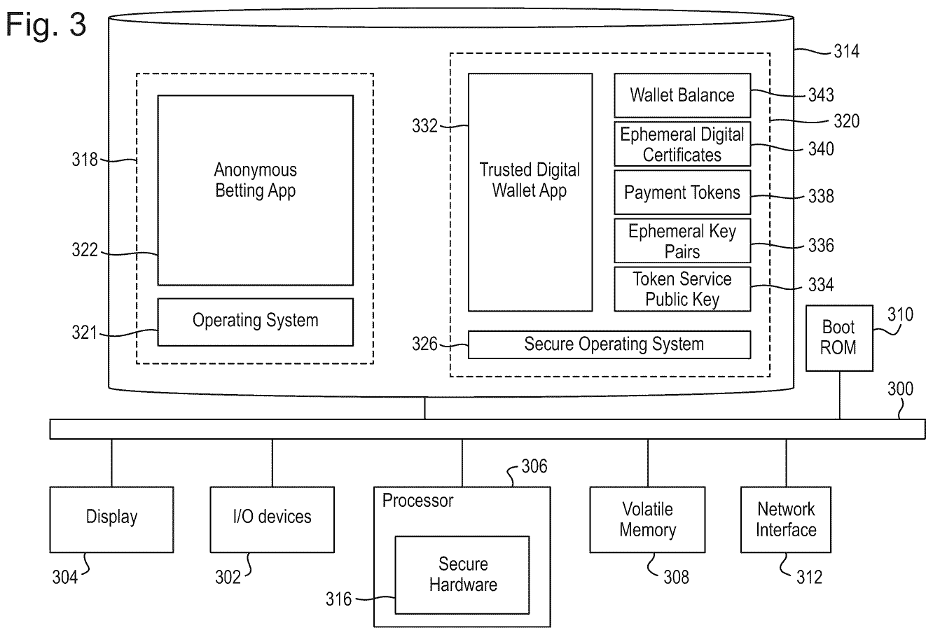

In some embodiments, the user device 202 has have the hardware/software architecture illustrated in FIG. 3. The user device 202 comprises control circuitry and various input/output devices, the control circuitry comprising processing circuitry and storage circuitry. The processing circuitry includes one or more processors 306, one or more network interfaces 312, and one or more digital communication busses 300 which connect input/output devices 302 (such as a computer mouse, trackpad, touchscreen, display screen 304, keyboard), and storage including volatile memory 308, a boot ROM 310, and a persistent store 314 (for example solid-state storage). In some embodiments, the processor 306 includes secure hardware 316 (including, for example, unique cryptographic keys physically built into the processor at the time of manufacture) supporting secure execution of code signed with a corresponding public key.

The one or more network interfaces 312 may include a local area network interface, which local area network may form part of an internetwork, for example an intranet or the Internet and thus connect the user device 202 to the token service 206, betting service 208 and betting control service 210.

The persistent store 314 may contain code offering two execution environments 318, 320. A first part 320 of the persistent store 314 contains programs offering and using a trusted execution environment, namely a secure operating system 326 and a trusted digital wallet app 332. The trusted digital wallet app 332 may store a Token Service public key (pk(TS)) 334, ephemeral public-private key pairs 336 generated by the trusted digital wallet app 332 or a key pair generation facility provided by the operating system, secure operating system or a library of software routines, one or more digital payment tokens 338 (which may include both issued tokens and assigned tokens as will be explained below), and one or more ephemeral digital certificates 340 issued by the Token Service certifying the use of respective ephemeral public keys in the computer network 200. The trusted digital wallet app 332 is designated as a trusted app because, for example, its code cannot be changed without causing the secure hardware 316 to refuse to execute the code since a public key operation performed on the binary code no longer gives a result which tallies with the private hardware key found in the secure hardware portion 316 of the processor 306.

The trusted execution environment may be provided by a hardware-based system using, for example, ARM's TrustZone technology, or the Software Guard Extensions built into some Intel CPUs.

In other embodiments, other security mechanisms for providing trustworthiness of the trusted digital wallet app 332 might be used. For example, software-based isolation might be relied upon instead. One particular example of software-based isolation would be using a separate application running on an Android operating system. In some embodiments, at least the private portion of ephemeral keys may be securely generated and/or stored on a cloud-based server, with cryptographic methods being used to ensure only the user can access the ephemeral key(s) stored on the cloud-based server.

The trusted digital wallet app 332 provides mechanisms both for making and receiving payments of tokens as will be described in more detail below. The betting service 208 may also have the digital wallet application which may run in a trusted execution environment.

The second part 318 of the persistent store 314 stores an operating system program 321 and an anonymous betting app 322. The anonymous betting app 322 offers the user a betting interface and cooperates with the trusted digital wallet app 332 to send digital payment tokens to, and receive digital payment tokens from, the betting service 208.

The anonymous betting app 322 may in some embodiments, be a native application running on the user device 202, or may be a web-based app or may be a hybrid app in which some functionality is provided by the user device software, and some functionality is provided by the betting service 208 (in particular the application server part of the betting service 208).

In the following description, messages are shown in curly brackets optionally followed by a cryptographic key that is used to encrypt the message. The notation for keys includes the name of the actor and type of the key. For example, pk(A) is a public key of the actor A and sk(B) is a private (secret) key of the actor B. A message M encrypted by a public key of B is described as {M}pk(B). The notation also allows an additional subscript to specify that the key pair is ephemeral key pair. For example, an ephemeral public key of the actor B is marked as pk(Bcph). Message structure fields, e.g., (M1 and M2), are presented as a comma separated list {M1, M2}. The character ‘#’ is used to represent a cryptographic hash algorithm. In the notation used here, a message M signed by the actor A, which may, for example, take the form {M}{#}sk(A), is represented as Signed {M}sk(A).

A user may load tokens onto a User Device 202 either in advance of making a bet or at the time of making a bet.

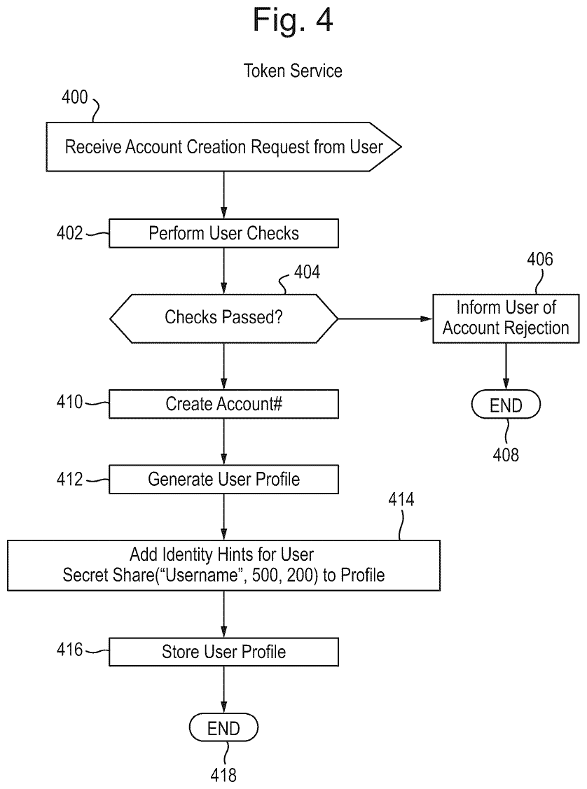

In some embodiments, before any tokens may be loaded onto a user device 202, the user is required to set up a user account following the process illustrated in FIG. 4. The process provides a basis for traceability in the event that the user breaches a spending or activity limit on the betting service 208, or, in some embodiments, on a plurality of betting services.

The account creation process (FIG. 4) begins with the receipt 400 by the token service 206 of an account creation request from a User Device 202. The token service 206 performs user checks 402 (e.g., age verification) and tests 404 to see if the user checks have been passed. If the user checks are not passed, a message informing the user that their account request has been rejected is transmitted 406 to the user device, and the account creation process ends.

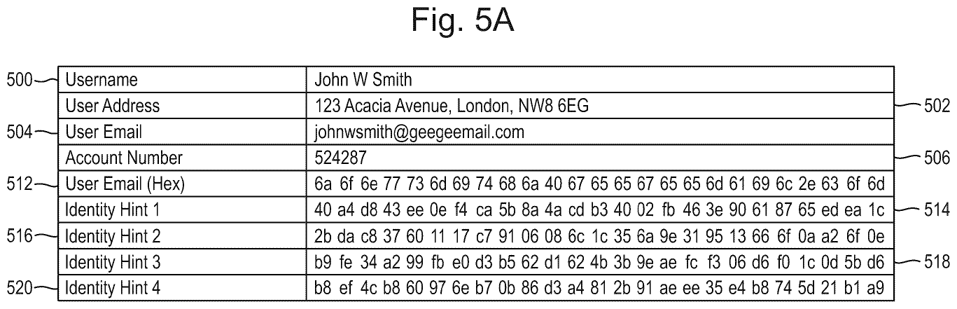

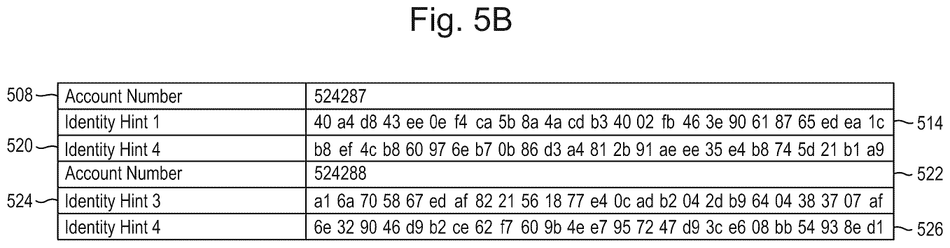

If, on the other hand, the checks are passed, then an account is created 410, and provided with an account number (Acc #). The token service may then generate 412 a user profile. As can be seen from FIG. 5A, the user profile may store the user's name 500, their address 502, a user identifier 504 (e.g., an email address), and the user's account number 506. In addition, a number of identity hints 514, 516, 518 and 520 are generated and added 414 to the user profile. In the example in FIG. 5A (given by way of illustration only), three identity hints 514, 516, 518 having the same length as the user's email address are randomly or pseudo-randomly generated, and then the user's email address (in binary form-here shown in hexadecimal notation 512) is XOR′ed with the three randomly generated identity hints to arrive at a fourth identity hint 520.

### IH4=IH1 ⊕IH2 ⊕IH3 ⊕User Email (Hex)

XOR'ing the four identity hints 514, 516, 518 and 520 together will then regenerate the user's email address 512. However, having any three of the four identity hints will reveal nothing about the user's identity. This is an example of a technique known as secret-splitting. In some cases, secret splitting is undesirable because it requires all of the ‘splits’ of the secret to be found before the secret (in this case the user's email address) is revealable. In such cases, secret sharing may be used. Secret sharing operates in a similar way, but the secret may be revealed with just some rather than all of the ‘shares’. For example, if the secret sharing algorithm is configured so that there are N identity hints, and M (where M<=N) are required to regenerate the identity, then a minimum of M identity hints must be known in order to regenerate the user identity. One secret sharing algorithm which may be used is Shamir's algorithm. Shamir's algorithm may be used in threshold mode. As a particular example, Daniel Silverstone's libgfshare-bin implementation can be used (commands gfsplit, gfcombine) if the token service 206 runs on a server running an operating system which supports those commands (e.g. Unix or the Ubuntu Linux operating system).

Returning to FIG. 4, in some embodiments, a secret sharing scheme is used to generate 414 a number of identity hints from an identifier of the user. In some embodiments, a system-wide betting rate limit is set, for example $250 per day. In one example, the scheme is configured to generate a number of identity hints N which is substantially higher (e.g., twice as high) as the number of currency units found in a system-wide betting limit, in such a way that a smaller subset of those identity hints M (e.g., around four-fifths of the number of currency units found in the system-wide betting limit), need be known in order to regenerate the user's identity. In an example where the system-wide betting limit is $250, and one identity hint is given per dollar's worth of token, then a N=500, M=200 secret sharing scheme may be employed (so, in practice, the token service may store 500 identity hints in each user profile). Once the identity hints have been generated, the user details and generated identity hints are stored 416 in persistent storage 207 associated with the token service 206. The user account creation process then ends 418.

FIG. 5B shows an example of an identity hint cache stored in the persistent storage of the betting control service 210. As will be explained below, as the user spends anonymous betting tokens with the betting service 208, the betting control service 210 learns identity hints from the user profile. On the user betting excessively, then the betting control service will store a sufficient number of identity hints (in this example, 200) to be able to regenerate the user identity from the hints.

A user may load tokens onto a User Device 202 either in advance of betting or at the time of betting.

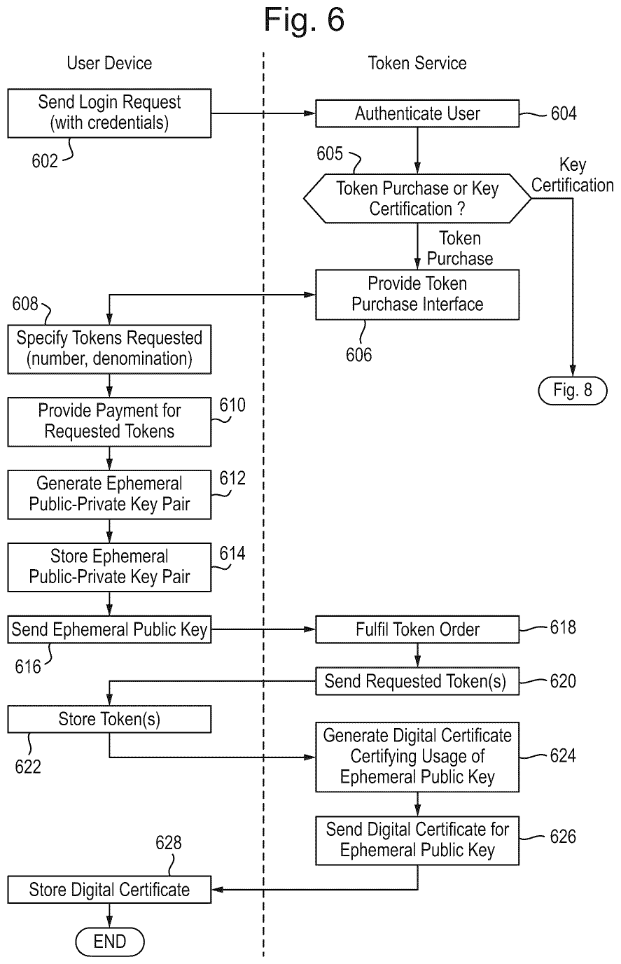

The process (FIG. 6) by which the trusted digital wallet application 332 loads tokens onto the user device 202, may begin with the User Device 202 (or the betting service 206 or any other network participant having a digital wallet application) sending 602 a login request to the Token Service 206. Login may simply require the user to enter a username and password, or more complex authentication, for example utilizing OAuth2.

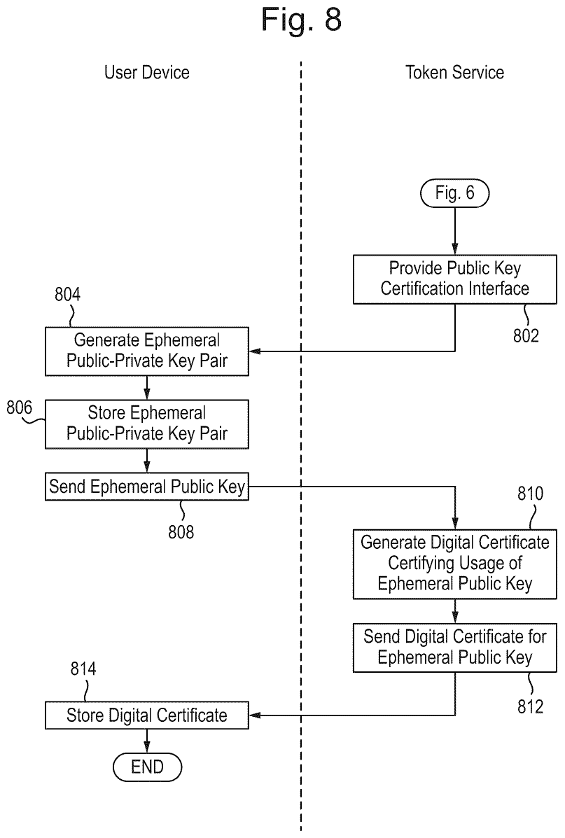

The Token Service 206 may then authenticate 604 the user, and provide 605 the user interface via the User Device 202 offering the user a choice between Token Purchase or Key Certification. Key Certification will be described below with reference to FIG. 8. If the user chooses Token Purchase then the Token Service 206 provides 606 a token purchase interface via the User Device 202. Using the token purchase interface, the user may then specify 608 the number of tokens requested, and their denomination. The user then provides payment 610 for the requested tokens, for example using a credit card payment, or by way of a bank transfer. The user device 202 generates 612 an ephemeral public-private key pair to be used only in relation to the tokens purchased in the current token purchase transaction. By generating and using different private-public key pairs for different sets of tokens, the User Device 202 is able to hinder other participants in the network from associating bets using tokens purchased in a different token purchase transaction with bets made by the same user using tokens purchased in the current token purchase transaction.

The User Device 202 then stores 614 the ephemeral public-private key pair, keeping the ephemeral private key secret, and sends 616 the Ephemeral Public Key pk(Uₑₚₕ) to the Token Service 206.

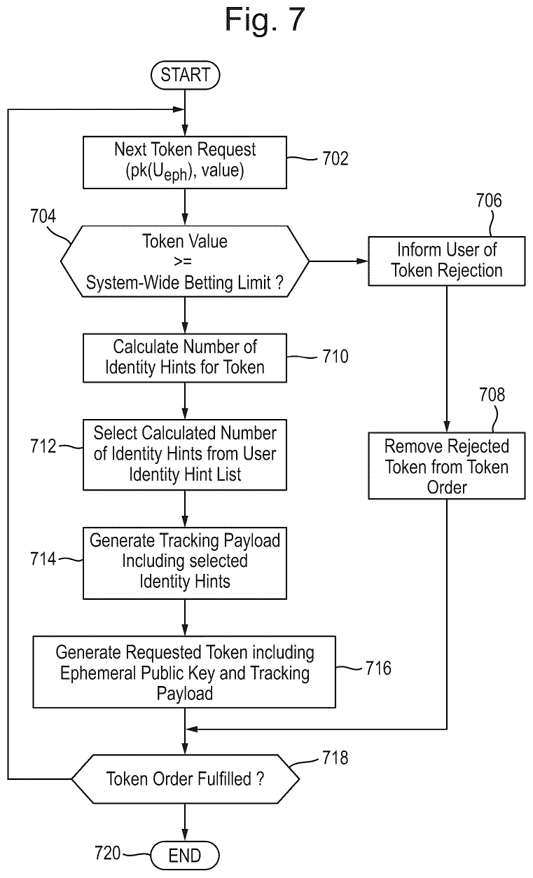

The Token Service 206 then fulfils 618 the token order using the Ephemeral Public Key provided by the User Device 202. This will be described in more detail below with reference to FIG. 7.

Having generated the requested tokens, the Token Service 206 sends 620 the requested tokens to the User Device 202. In some embodiments, the tokens are sent in a message encrypted with the consumer ephemeral public key to ensure only the User Device 202 can extract the tokens from the encrypted message.

On receiving the requested tokens, the User Device 202 stores 622 the tokens for use in future privacy-preserving payments.

The Token Service 206 then generates 624 a digital certificate certifying usage of the ephemeral public key in payment tokens in network 200. The certificate may be formatted as follows:

### Certificate:

### Signed{pk(Uₑₚₕ)}sk(TS)

The certificate does not include any indication of the identity of the user or the User Device 202. The Token Service 206 digitally signs the certificate with the private key corresponding to the Token Service public key 334 stored in the User Device 202 and the betting service 208.

Finally, the Token Service 206 sends 626 the digital certificate (note one digital certificate may relate to a large number of tokens purchased in a single transaction) to the User Device 202, which stores 628 the digital certificate 340 for use in future payments.

Turning to FIG. 7, the fulfilment of a token order by the token service 206 may begin with a token request 702 which includes the value of the token and the ephemeral public key to be included in the token. The value of the requested token may then be compared 704 to the system-wide betting limit. If the value of the requested token exceeds the system-wide betting limit, then the user may be informed 706 that the token request has been rejected, and consequently, the rejected token is removed from the token order.

If the token value is found not to exceed the system-wide betting limit, then a number of identity hints that corresponds to the value of the token may be calculated 710. The number of identity hints may equal, or be a fixed multiple or fraction of the value of the token in US dollars. It will be remembered that M is the number of unique shares required in order to be able to regenerate the user's identity. In some embodiments, identity hints may be re-used in other tokens provided to the user (e.g., tokens issued on an earlier day). In some embodiments, in order to allow for the possibility of duplicate identity hints offering no further progress towards identifying a user, the number of identity hints required to identify the user might set to fewer than a directly proportional amount. To give an example, if the limit is set to $250, and an identity hint is added to a token for each $1 of value in that token, then the secret sharing scheme might be configured so that M is lower than 250. Hence, on average, if the user spends $250 in tokens on the betting service, they will enable the betting control service 210 to regenerate the user's identity despite a fraction of the identity hints in the tokens being duplicates. In other embodiments, M might be set to the limit (so, for a $250 limit, M would be set to 250), but the number of identity hints loaded into a token might be greater than one per $1 value in the token. For example, four identity hints might be loaded into the token for each $3 of value in the token. In some embodiments, a combination of both approaches may be used. In yet other embodiments, the user may be required to spend the tokens in the order they are issued by the token service.

Having calculated how many identity hints should be loaded into the token, the token service 206 selects that number of identity hints from the list of identity hints 514, 516, 518, 520 stored with the user profile (FIG. 5). The selection may simply be of the next identity hints in the list. In other embodiments, the identity hints may be randomly or pseudo-randomly selected from the list.

The token service then generates 714 a tracking payload including the selected identity hints (shown as [hᵢ]ₙ below). In addition, the tracking payload may include a pseudonym of the user (in this particular example, the user's account number with the Token Service 206) and a random number (shown as R_{B}). The combination (e.g., concatenation) of the user pseudonym, the random number R_{B}, and the one or more identity hints may then be signed with a public key of the betting control service (CS) 210 to hide the identity hints from entities other than the betting control service 210 (in particular, to hide the identity hints from the betting service 208). In other embodiments, the user pseudonym can be provided by a public key of the user, or a cryptographic hash of the user's public key. The presence of the random number R_{B} in the tracking payload may prevent the user from deliberately choosing tokens having duplicate tracking payloads in order to avoid triggering censure by the betting control service 210.

### Tracking Payload:

{Acc #, R_{B}, [hᵢ]ₙ}pk(CS)}

The token service 206 then generates 716 the request token.

Each token may take the format illustrated below.

### Token:

Signed {pk(Uₑₚₕ), value, R_{A}, sequence, expiration, tracking payload}sk(TS)

In some embodiments, each token contains six fields, namely the ephemeral public key provided by the User Device 202, an indication of the value of the token, a unique random or pseudorandom number R_{A}, an assignment sequence number, an expiration time for the token, and the tracking payload.

In such embodiments, random number R_{A} may be used in order to provide traceability if misuse of the payment system is detected. In some embodiments, on issuing a token, the Token Service 206 may make an entry in an audit log and later query that audit log to find connection details or other identification information (e.g., credit card details or bank details) relating to the person to whom the token was issued. In embodiments where a different ephemeral key pair is generated for each token, the token is unique without the random number (R_{A}) field, and random number (R_{A}) may not be required to provide traceability. Similarly, in some cases the expiration time may be specified with such precision that the token is unique without the random number (R_{A}) field. However, the random number field may be the only field that is directly generated by Token Service in cases where the client wallet software is able to use the same ephemeral key for multiple tokens and the expiration time of the token is insufficiently precise to render the token unique.

Aside from the tracking payload, the token does not include any indication of the identity of the user or the User Device 202.

The token generation process then checks to see whether each token in the token order has been generated. If not, the process is repeated for the next token request. If so, the token generation process ends 720.

In other embodiments, each token may be of a fixed value, and include a fixed number (e.g., one) of identity hints. In yet other embodiments, a weighted threshold secret sharing scheme may be used where the weight of the secret share corresponds to the value of the token.

In a two-party payment transaction, there are four scenarios, as illustrated in the table below:

| | Payer Reveals Identity | Payer Hides Identity |
|---|---|---|
| Payee Reveals | Mutual Disclosure | Payee-only Identity |
| Identity | | Disclosure |
| Payee Hides | Payer-only Identity | Mutual Anonymity |
| Identity | Disclosure | |

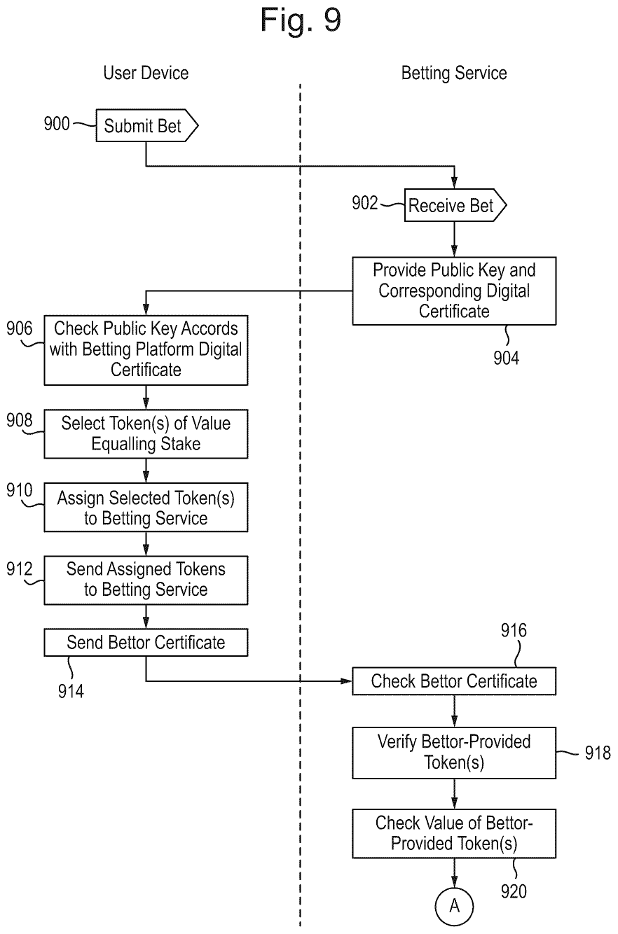

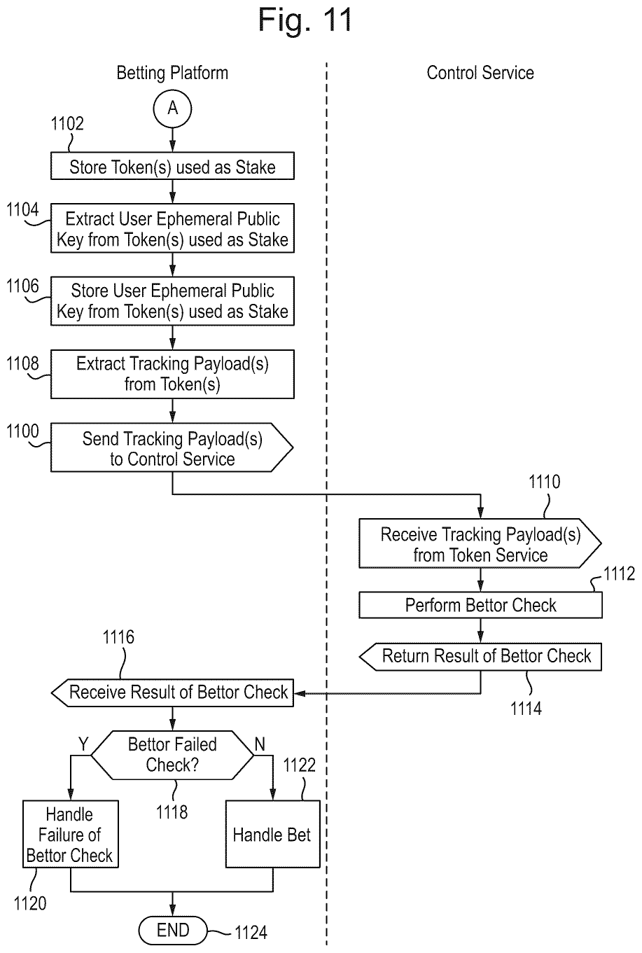

Any party which wishes to preserve its payment privacy can choose to use ephemeral public-private key pairs in a payment transaction. The example explained below in relation to FIGS. 9 and 11 relates to a transaction in which the payer seeks to preserve their payment privacy whilst the payee chooses to reveal their identity. A party (payer or payee) which is not concerned to preserve its payment privacy may use a fixed public-private key pair in place of the use of an ephemeral public-private key pair.

As mentioned above in relation to FIG. 6, in order to support mutual anonymity, the Token Service 206 may additionally offer a key certification service as illustrated in FIG. 8.

On a user device 202 (for the scenario envisaged here, the user device 202 seeks to be paid anonymously) choosing the public key certification service, the Token Service 206 provides 802 the user device 202 with a public-key certification interface.

To start the process of enabling the anonymous receipt of payment, the user device 202 generates 804 an ephemeral public-private key pair. The user device 202 then stores 806 the ephemeral public-private key pair, keeping the ephemeral private key secret, and sends 808 the Ephemeral Public Key pk(Uₑₚₕ) to the Token Service 206.

The Token Service 206 then generates 810 a digital certificate certifying usage of the ephemeral public key in payment tokens in the computer network 200. The certificate may be formatted as follows:

### Certificate:

### Signed{pk(Uₑₚₕ)}sk(TS)

The certificate does not include any indication of the identity of the user or the user device 202. The Token Service 206 digitally signs the certificate with the private key corresponding to the Token Service public key 334 stored in user device 202 and the betting service 208.

Next, in FIG. 8, the Token Service 206 sends 812 the digital certificate (note one digital certificate may relate to a large number of tokens purchased in a single transaction) to the User device 202, which stores 814 the digital certificate 340 for use in future payments.

A token assignment process which may be used to make a privacy-preserving payment from user device 202 to the betting service 208 will now be described with reference to FIGS. 9 to 11. The payment process is triggered when the user submits 900 a bet (e.g., by clicking on a ‘Place Bet’ button as discussed above in relation to FIG. 1). In general, the payment process may be initiated by either the user device 202 making the payment (‘payer’) or the betting service 208 receiving the payment (‘payee’). In the example shown in FIGS. 9 to 11, the payment process is initiated by the payer. The anonymous betting app 322 may control the user device 202 to send 902 an anonymous payment request to the payee.

The payee may respond to the payment request by sending 904 a (in this case fixed) payee public key and corresponding payee digital certificate to the payer.

The payer checks 906 that the payee public key accords with the payee digital certificate received in step 904. The payer may then select 908 a token whose value matches the stake from the payment token store 338. In that case, the token will be one purchased in advance by the user using the process described above with reference to FIG. 6. In other embodiments, the payment process being described here might include the token acquisition illustrated with reference to FIG. 6 at the time when the bet is submitted.

Now provided with the payee public key, if the payee public key matches the certificate, the payer generates 910 an Assigned Token which the payee (in this example, the payee is the betting service (BS)) can either redeem for money at the Token Service 206 or use for one or more anonymous payments to user device 202 or other devices in the computer network 200. The Assigned Token may be formatted as below:

### AssignedToken1:

Signed{{token}, pk(BS), value, ++sequence} sk(Uₑₚₕ)

The Assigned Token may comprise the token to be assigned (an ‘embedded token’), and an added assignment layer.

The payer adds the assignment layer by digitally signing, with the ephemeral private key paired with the ephemeral public key seen in the embedded token, a combination of i) the embedded token, ii) the payee public key (obtained from the payee in step 904), iii) the value being assigned (which may be equal to the embedded token), and iv) an assignment sequence number (the notation ‘++sequence’ describes that the sequence number found in the embedded token is incremented and then used inside the message body to be signed).

To prevent double-spending of tokens in the computer network, the trusted code of the trusted digital wallet app 332 on the user device 202 may only enable:
i) the generation of a single Assigned Token which matches the value of a received token or Assigned Token; or
ii) the generation of a plurality of Assigned Tokens whose combined value matches the value of a received token or Assigned Token.

In some embodiments, a value field is found in the assignment layer and allows for divisibility of tokens. However, in other embodiments, the value field may be omitted from the assignment layer, the value of the assigned token then being determined by the value field in the embedded token.

The payer then sends 912 the Assigned Token to the payee, and sends 914 the payer ephemeral digital certificate certifying the ephemeral payer public key included in the embedded token (the ephemeral digital certificate, it will be remembered, was supplied with the token by the Token Service 206).

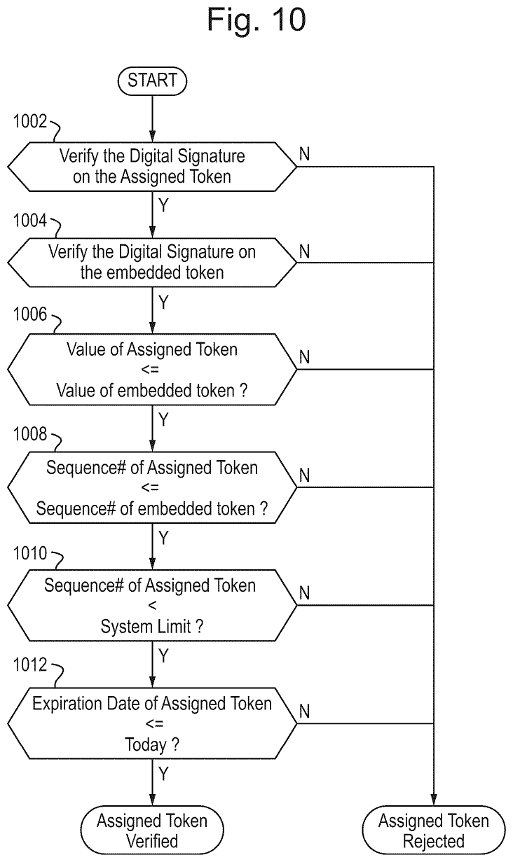

On receipt of the Assigned Token and the payer ephemeral digital certificate, the payee checks 916 the payer ephemeral digital certificate for an ephemeral public key pk(Uₑₚₕ) found in the embedded token using the locally-stored Token Service public key 334. Assuming that check is passed, the Token Service 206 verifies 918 the Assigned Token using the verification process which will described below with reference to FIG. 10. The Token Assignee may further check 920 that the value of the token is equal to the declared stake.

Turning now to FIG. 10, on receiving an Assigned Token, a trusted digital wallet app 332 running on the betting service 208 may check the Assigned Token—by, for example:
i) using the ephemeral public key (pk(Uₑₚₕ)) found in the token embedded in the Assigned Token, verifying 1002 the ephemeral private key sk(Uₑₚₕ), used in the processing of adding the assignment layer, pairs with the ephemeral public key pk(Uₑₚₕ) included in the embedded token;
ii) using the Token Service's public key, verifying 1004 the Token Service's signature on the embedded token;
iii) checking 1006 that the value in the Assigned Token is less than or equal to the value in the embedded token.
iv) checking 1008 that the sequence number in the Assigned Token is higher than the sequence number in the embedded token;
v) checking 1010 that the sequence number (‘++sequence’) in the Assigned Token does not exceed a system limit for the sequence number;
vi) checking 1012 that the expiration date/time of the embedded token has not passed.

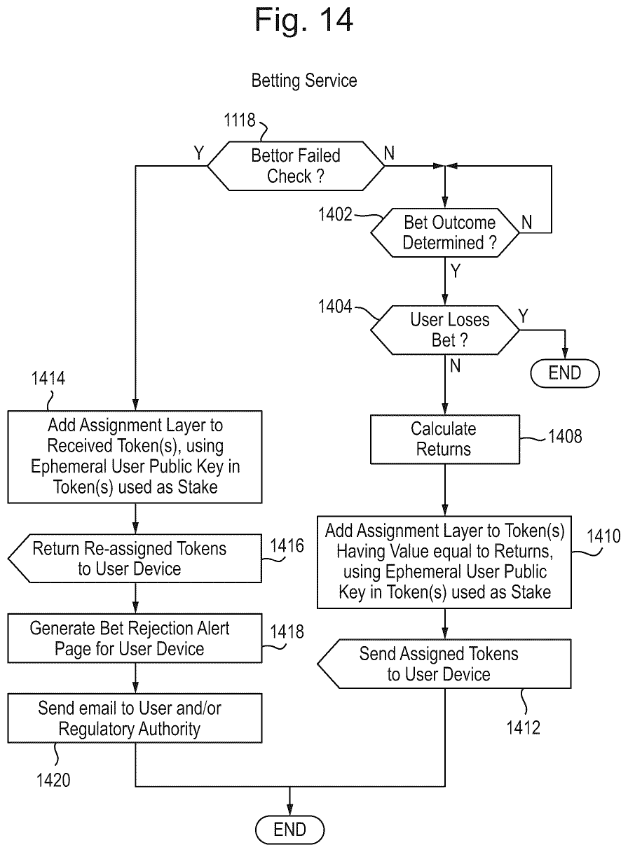

If any of these checks and verifications are not met, then the payee may refuse to accept the token, may message the payer to indicate the refusal to accept the payment and may re-assign the token to the user device using the reassignment process described in relation to FIG. 14 below.

Turning now to FIG. 11, once checks have been made on the token(s) provided by the bettor, the betting service 208 may store 1102 the token(s) in the protected memory space of the Trusted Digital Wallet app 332. Thereafter, the betting service 208 may extract 1104 the ephemeral public key pk(Uₑₚₕ) included in the embedded token from each of the one or more assigned token(s), and may store 1106 the user ephemeral public key pk(Uₑₚₕ) for use in anonymously refunding (if required) or anonymously paying any winnings to the bettor.

The betting service 208 may then extract 1108 the tracking payload from each of the one or more assigned token(s), and send 1100 the one or more tracking payloads to the control service 210.

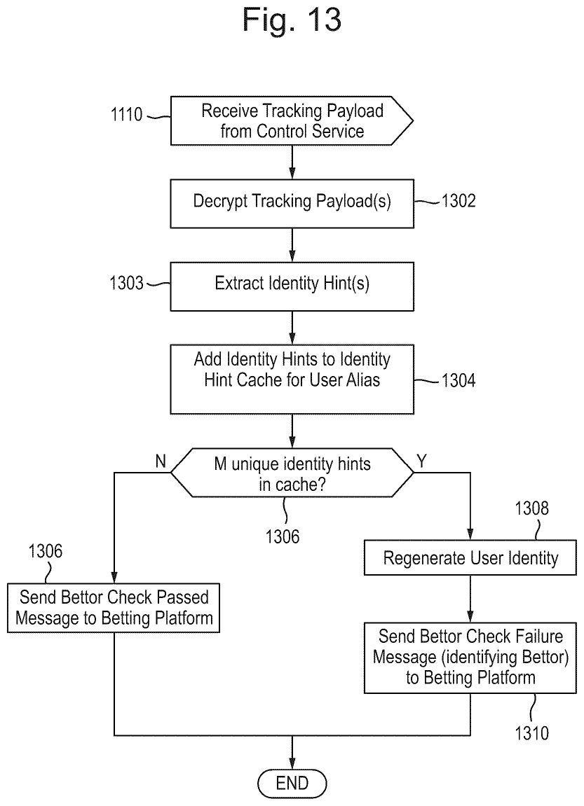

On receiving 1110 the one or more tracking payloads, the control service 210 may perform a bettor check 1112 which will be described in more below with reference to FIG. 13. The betting control service 210 then returns 1114 the result of the bettor check to the betting service 208.

On receiving 1116 the result of the bettor check, the betting service may test 1118 whether the received result indicates that the bettor failed the bettor check. If the received result indicates that the bettor failed the bettor check, then the betting service 208 handles 1120 the bettor failing the check. If the received result indicates that the bettor passed the bettor check, then the betting service handles 1122 the bet. These steps will be explained in more detail below with reference to FIG. 14. The betting process then ends 1124.

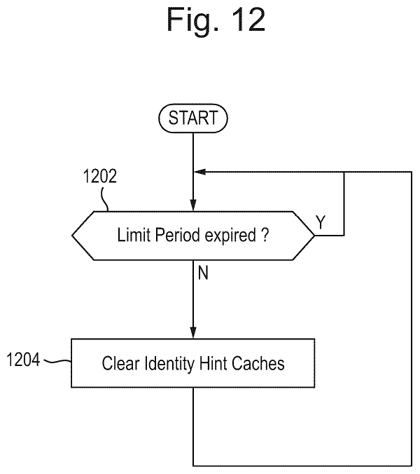

FIG. 12 illustrates a cache clearance process which may be performed by the betting control service 210 periodically (for example, more than once per day, once per day, once per week, twice per week). The betting control service 210 may wait 1202 for the time period to expire, and on finding that the time period has expired, the control service may clear 1204 each of the identity hint caches (FIG. 5B).

FIG. 13 illustrates the bettor check process (FIG. 11, step 1112), which may be performed by the betting control service 210, in more detail. The bettor check process may begin with the decryption 1302 of the one or more tracking payloads from each of the one or more tokens used by the user to pay for the bet (e.g., by using a private key of the betting control service 210). The one or more identity hints may then be extracted 1303 from the decrypted tracking payloads. The betting control service may then add 1304 the extracted identity hints to the cache of identity hints maintained for the user (the betting control service 210 is able to attribute the identity hints to the correct user cache by using the Acc #alias found in the tracking payload). The betting control service 210 may then test 1306 whether there are at least M unique identity hints in the cache for the user alias. If there are at least M unique identity hints in the cache for the user alias, then the betting control service may run a regeneration part of the secret sharing protocol to regenerate 1308 the user identifier (e.g., the user's email address). The betting control service may then send 1310 a message including the bettor's email address and an indication that the bettor has failed the bettor check to the betting service 208. In the event that there are not M unique identity hints in the user alias cache, a message indicating that the bettor has passed the bettor check may be sent to the betting service 208.

FIG. 14 illustrates the processing 1120 which may be performed by the betting service 208 if the bettor check is failed, or the handling 1122 of the bet if the bettor check is passed.

If the bettor check is passed, then the outcome of the event to which the user's bet relates is awaited 1402. Once the outcome is known, the betting service may determine 1404 whether the user has won or lost the bet. In the event that the user has lost the bet, the process ends 1406. If, on the other hand, the user has won the bet, the return owed to the bettor may be calculated 1408. The betting service 208 may then obtain a token from the token service for the corresponding value, and add an assignment layer to the token as described above in relation to the payment of the stake by the user to the betting service. In the case of the return payment, the assignment involves using the ephemeral public key stored (FIG. 11, step 1106) on receiving the stake, and signing the combination of the token and the assignment layer with the private key of the betting service.

The assigned token(s) are then returned 1412 to the user device 202. This message may be a reply to the message by which the user placed the bet (FIG. 9, step 902).

If the bettor check is failed, then the tokens used in placing the bets may be assigned back 1414 to the user using the ephemeral public key found in the embedded token in each assigned token received. The reassigned tokens are then returned to the user device 202 by way of a reply to the message by which the user placed the bet (FIG. 9, step 902).

The betting service may then generate 1418 a bet rejection alert page like that seen in FIG. 1. Additionally, the betting service may send an email to the user's email address (revealed in the bettor check failure message) explaining that the daily betting limit has been reached and offering counselling services and the like. The user's email address may also be passed to a regulatory authority.

It will be seen how the computer network is configured to enable anonymous betting, but to reveal the identity of a user who exceeds a predetermined betting limit.

In some embodiments, instead of the betting control service 210 being provided on a separate computer from the betting service 208, the two services are provided on the same computer, or on two or more computers under the administration of a common administrator. Also, in some embodiments, the tracking payload may not be encrypted, and thus the user's pseudonym (in the example above, the user's account number) will be available to the betting service 208. In either case, the betting service 208 can profile the user by using the user's pseudonym. In such cases, the token service may replace the long-lived pseudonym (e.g., token service account number) with a temporary pseudonym which is used only during a time period T. The time period might, for example, be one day, less than one day, one week or between one day and one week, a month or between one week and one month, or any other time period suitable for stymying attempts by the betting service 208 to profile the user based on the temporary pseudonym.

In some embodiments, the betting control service 210 may be shared by a plurality of different betting services. In such cases, each of the plurality of betting services 208 may send tracking payloads received from a user to the shared betting control service 210. In response to the shared betting control service 210 receiving enough identity hints to reveal the bettor's identity, the betting control service 210 may send a bettor check failure message to the betting service 208 which will reject the bet which provided the last required identity hint. Thereafter, any bet placed by the bettor at any other one of the plurality of betting services 208 sharing the betting control service 210 (before the betting control service clears the identity hint cache) may trigger a bettor check failure message owing to the betting control service 210 having gathered sufficient identity hints from the betting services 208 sharing the betting control service 210. In this way, the shared betting control service 210 may control the betting activities of a bettor across several different betting sites.

The processes described above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
receiving, from a computing device, one or more inbound digital payment tokens comprising:
a) an inbound predecessor digital payment token previously generated by digitally signing inbound predecessor data including an ephemeral public key, and
b) an inbound assignment layer added to the inbound predecessor digital payment token by digitally signing, with an ephemeral private key corresponding to the ephemeral public key in the inbound predecessor data, inbound assignment data including a counterparty public key and the inbound predecessor digital payment token; and
in response to receiving the one or more inbound digital payment tokens from the computing device, extracting the ephemeral public key from the inbound predecessor digital payment token;
generating an outbound digital payment token comprising:
c) an outbound predecessor digital payment token generated by digitally signing outbound predecessor data including a counterparty public key, and
d) a return assignment layer added to the outbound predecessor digital payment token by digitally signing, with a counterparty private key corresponding to the counterparty public key in the outbound predecessor data, outbound assignment data including the extracted ephemeral public key and the outbound predecessor digital payment token; and
sending, to the computing device, the outbound digital payment token.

2. The method of claim 1, wherein a plurality of inbound digital payment tokens are received from one or more computing devices, each of the plurality of inbound digital payment tokens further including a tracking payload including a hint of a consumer identifier;
the method further comprising:
storing the received hints for each consumer identity; and
in response to receiving sufficient hints to reveal a consumer identifier, reconstructing, from the stored hints for a consumer identifier, the consumer identifier.

3. The method of claim 2, wherein the tracking payload is encrypted, and a control service is arranged in operation to: decrypt the tracking payload using a cryptographic key; and perform the storing of the received hints for each consumer, and the reconstructing of the consumer identifier.

4. The method of claim 2, further comprising, in response to reconstructing the consumer identifier, sending a request to a token service to at least reduce the provision of digital payment tokens to the identified consumer.

5. The method of claim 4, wherein the tracking payload is encrypted, and a control service is arranged in operation to: decrypt the tracking payload using a cryptographic key; and perform the storing of the received hints for each computing device, the reconstructing of the consumer identifier, and the sending of the request to the token service to at least reduce the provision of digital payment tokens to the identified consumer.

6. The method of claim 1, further comprising receiving from the computing device, an ephemeral certificate in which data comprising the ephemeral public key is signed with a token service private key.

7. The method of claim 1, wherein the inbound predecessor digital payment token comprises a digital payment token generated by a token service by digitally signing the ephemeral public key with a token service private key.

8. The method of claim 1, wherein the outbound digital payment token comprises the inbound digital payment token and the return assignment layer.

9. The method of claim 1 further comprising, in response to receiving the one or more inbound digital payment tokens from the computing device:
calculating a return payment amount; and
obtaining the outbound predecessor digital payment token for the calculated return payment amount.

10. The method of claim 1 further comprising, in response to receiving the one or more inbound digital payment tokens from the computing device:
calculating a return payment amount; and
including the calculated return payment amount in the return assignment layer added to the outbound predecessor digital payment token.

11. A system comprising:
memory storing instructions; and
control circuitry configured to execute the instructions to:
receive, from a computing device, one or more inbound digital payment tokens comprising:
a) an inbound predecessor digital payment token previously generated by digitally signing inbound predecessor data including an ephemeral public key, and
b) an inbound assignment layer added to the inbound predecessor digital payment token by digitally signing, with an ephemeral private key corresponding to the ephemeral public key in the inbound predecessor data, inbound assignment data including a counterparty public key and the inbound predecessor digital payment token; and
in response to receiving the one or more inbound digital payment tokens from the computing device, extract the ephemeral public key from the inbound predecessor digital payment token;
generate an outbound digital payment token comprising:
c) an outbound predecessor digital payment token generated by digitally signing outbound predecessor data including a counterparty public key, and
d) a return assignment layer added to the outbound predecessor digital payment token by digitally signing, with a counterparty private key corresponding to the counterparty public key in the outbound predecessor data, outbound assignment data including the extracted ephemeral public key and the outbound predecessor digital payment token; and
send, to the computing device, the outbound digital payment token.

12. The system of claim 11, wherein a plurality of inbound digital payment tokens are received from one or more computing devices, each of the plurality of inbound digital payment tokens further including a tracking payload including a hint of a consumer identifier, and the control circuitry is further configured to:
store the received hints for each consumer identity; and
in response to receiving sufficient hints to reveal a consumer identifier, reconstruct, from the stored hints for a consumer, a consumer identifier.

13. The system of claim 12, wherein the tracking payload is encrypted, and the system further comprises a control service arranged in operation to: decrypt the tracking payload using a cryptographic key, store the received hints for each consumer and reconstruct the consumer identifier.

14. The system of claim 12, wherein the control circuitry is further configured to, in response to reconstructing the consumer identifier, send a request to a token service to at least reduce the provision of digital payment tokens to the identified consumer.

15. The system of claim 14, wherein the tracking payload is encrypted, and the system further comprises a control service arranged in operation to: decrypt the tracking payload using a cryptographic key, store the received hints for each consumer identity, reconstruct the consumer identifier, and send a request to the token service to at least reduce the provision of digital payment tokens to the identified consumer.

16. The system of claim 11, wherein the control circuitry is further configured to receive from the computing device, an ephemeral certificate in which data comprising the ephemeral public key is signed with a token service private key.

17. The system of claim 11, wherein the inbound predecessor digital payment token comprises a digital payment token generated by a token service by digitally signing the ephemeral public key with a token service private key.

18. The system of claim 11, wherein the outbound digital payment token comprises the inbound digital payment token and the return assignment layer.

19. The system of claim 11, wherein the control circuitry is further configured to, in response to receiving the one or more inbound digital payment tokens from the computing device:
calculate a return payment amount; and
obtain the outbound predecessor digital payment token for the calculated return payment amount.

20. The system of claim 11, wherein the control circuitry is further configured to, in response to receiving the one or more inbound digital payment tokens from the computing device:
calculate a return payment amount; and
include the calculated return payment amount in the return assignment layer added to the outbound predecessor digital payment token.

21-49. (canceled)
